(19) United States
(12) Patent Application Publication
(10) Pub. No.: US 2026/0354614 A1
(43) Pub. Date: Nov. 12, 2026

(54) POACHED EGG PREPARATION MACHINE AND POACHED EGG PREPARATION METHOD

(71) Applicant: SHAO-LIN HSU, Taoyuan City (TW)

(72) Inventor: SHAO-LIN HSU, Taoyuan City (TW)

(21) Appl. No.: 19/203,530

(22) Filed: May 9, 2025

(51) Int. Cl. A47J 29/02; A23L 15/10; A47J 29/06; A47J 43/14; B65B 25/00

(52) U.S. Cl. CPC A47J 29/02; A23L 15/10; A47J 29/06; A47J 43/145; B65B 25/001

(57) ABSTRACT

A poached egg preparation machine includes a raw egg processing module having a raw egg input end, an egg yolk output end, and an egg white output end; a cooling molding module including a conveying track, forming molds, egg yolk disposing elements, egg white nozzles, an egg yolk cooking unit, and an egg yolk cooling unit, the egg yolk disposing elements and the egg white nozzles receiving egg yolk and egg white from the raw egg processing module for filling into the forming molds, the forming molds being horizontally rotatable to set the egg yolk at the center, the egg yolk being cooked and completely cooled before filling; a poaching module connected to the conveying track for heating and cooking the forming molds; and a cooling module for cooling the forming molds to take out the poached eggs.

### BACKGROUND OF THE INVENTION

### (a) Technical Field of the Invention

The present invention relates generally to a poached egg cooking apparatus, and more particularly to a poached egg preparation machine that first prepares a cooked yolk and then disposes the cooked yolk and raw egg white into a mold for cooking together.

### (b) Description of the Prior Art

Eggs are a very familiar food ingredient to people. Whether they are raw eggs, liquid eggs, or boiled eggs, they are widely available in the market and used in foods such as bread and cakes. However, the conventional way of making poached eggs cannot achieve a 100% yield rate and waste of raw materials may occur. In addition, domestic and foreign machines have been unable to solve the problem of cooling poached eggs for decades. Incompletely cooled poached eggs will ferment, causing food safety concerns.

### SUMMARY OF THE INVENTION

The primary objective of the present invention is to provide a poached egg preparation machine, in which egg yolk and egg white are first taken out of the eggshell, and the egg yolk is first cooked and completely cooled, and is then filled into a mold with the egg white, wherein the mold is then cooked and completely cooled, and a perfect poached egg can be obtained after demolding.

Commonly seen meatball foods are often made from fish or meat into a slurry, which is then shaped, cooled and cooked before being eaten; jelly foods are also often made by adding fruit and other fillings to the jelly and then cooling it to shape. The present invention adopts a similar concept by first taking cooked egg out of raw eggs, and having the egg yolk first cooked and cooled by means of an egg yolk cooking unit and an egg yolk cooling unit, and the cooked yolk and the raw egg white are respectively stuffed into an egg-shaped forming mold by means of an egg yolk disposing element and an egg white nozzle, so that the cooked yolk is implanted in a center area of the raw egg white in a way similar to filling stuffing into a jelly block. After being cooked and completely cooled before being taken out, a perfect poached egg with no food safety problem can be obtained, which completely solves the food safety problem caused by the loss of yield and insufficient cooling of poached eggs.

To achieve the above objective, the present invention provides a poached egg preparation machine, which comprises: a raw egg processing module, which comprises a raw egg input end, an egg yolk output end, and an egg white output end, wherein a plurality of raw eggs enters through the raw egg input end and the raw egg processing module separates each of the raw eggs into a raw egg yolk and a raw egg white; an egg yolk cooking and cooling molding module, which comprises a conveying track, a plurality of forming molds, a plurality of egg yolk disposing elements, a plurality of egg white nozzles, an egg yolk cooking unit, and an egg yolk cooling unit, wherein each of the forming molds is detachably arranged on the conveying track, and each of the forming molds is rotatable and flipping horizontally; each of the egg yolk disposing elements and each of the egg white nozzles are arranged at one end of the conveying track, and the egg white nozzles are connected to the egg white output end; the egg yolk cooking unit and the egg yolk cooling unit are connected and are arranged in sequence between the egg yolk output end and each of the egg yolk disposing elements, and the raw egg yolks enter the egg yolk cooking unit from the egg yolk output end to be cooked into a plurality of cooked yolks, and each of the cooked yolks enters the egg yolk cooling unit for low temperature cooling; each of the egg white nozzles fills the raw egg white into each of the forming molds, and each of the egg yolk disposing elements disposes each of the cooked yolks into the raw egg white in each of the forming molds; a poaching module, which is connected to an output end of the conveying track, wherein the poaching module receives and heats each of the forming molds to have the raw egg white cooked into a cooked egg white, wherein in each of the forming molds, the cooked egg white covers the cooked yolk to form a cooked egg; and a cooling module, which is connected to an output end of the poaching module, and the cooling module receives and cools, at a low temperature, each of the forming molds.

Preferably, temperature of the egg yolk cooling unit 25 and the cooling module 4 are set to −5 degrees to 5 degrees Celsius.

In the present invention, the raw egg processing module cracks the eggshells of the raw eggs and separates the raw egg yolk and the raw egg white. The egg yolk is first cooked and cooled by means of the egg yolk cooking unit and the egg yolk cooling unit. The cooked yolk and the raw egg white are respectively filled and stuffed into an egg-shaped forming mold by means of the egg yolk disposing element and the egg white nozzle, wherein a small amount of the raw egg white is first filled in and cooked, and then, the cooked yolk is filled. The cooked yolk is implanted, in a way similar to filling stuffing into a jelly block, in a center area of the raw egg white, and then, the forming mold is moved to the poaching module. During the course of movement for poaching, the forming mold is kept continuously rotating and flipping horizontally to set the egg yolk at the center without contacting the forming mold, thereby keeping a finished production of poached egg beautiful. After cooking, the cooked egg in each forming mold is completely cooled by the cooling module and becomes a perfect and flawless poached egg, so as to completely solve the food safety problems caused by the loss of yield of poached eggs and insufficient cooling.

In one embodiment, a packaging module is further included and connected to an output end of the cooling module. When each of the forming molds is cooked in the poaching module and cooling in the cooling module is completed, the forming mold is opened in the packaging module to release the cooked egg for packaging, wherein the packaging is implemented with a barrel or a bag. The size and weight of the finished product of poached eggs can be controlled by using forming molds of different capacities, in order to meet the size requirements of different businesses.

In one embodiment, the forming molds are each a product of metal or a product of a food grade material, such as stainless-steel molds or filling bags.

In brief, the present invention first cooked the raw egg yolk and the cooked yolks is cooled and then disposed into a mold for poaching with the raw egg white and then cooling to allow the poached egg production line yield to reach 100%, avoiding waste of raw materials and the related food safety problems caused by insufficient cooling.

According to the above, steps of a poached egg preparation method according to the present invention poaching comprise:
raw egg processing, in which a plurality of raw eggs are placed in a raw egg processing module, and the raw egg processing module 1 cracks eggshells and separates the raw egg yolk and the raw egg white of each of the raw eggs;
raw egg yolk cooking, in which the raw egg yolks are cooked by an egg yolk cooking unit to form a plurality of cooked yolks B1;
cooked yolk cooling, in which each of the cooked yolks enters an egg yolk cooling unit for low temperature cooling;
disposing into mold, in which the raw egg white is fed through a plurality of egg white nozzles into a plurality of forming molds, and the cooked yolks are respectively disposed into the raw egg whites in the forming molds by means of a plurality of egg yolk disposing elements;
poaching, in which the forming molds that contain the raw egg whites and the cooked yolks are heated by a poaching module to have the raw egg whites cooked into cooked egg whites, and in each of the forming molds, the cooked egg white covers and encloses the cooked yolk to form a cooked egg; and
cooling and demolding, in which each of the forming molds is cooled at a low temperature by a cooling module, and each of the forming molds is then opened to take out the cooked egg.

The method optionally includes the following step: packaging, in which the cooked eggs are classified and packaged according to a predetermined quantity or a predetermined weight.

### BRIEF DESCRIPTION OF THE DRAWINGS

FIG. 1 is a schematic view showing the present invention.

FIG. 2 is a first schematic view illustrating a flow of use of the present invention.

FIG. 3 is a second schematic view illustrating the flow of use of the present invention.

FIG. 4 is a third schematic view illustrating the flow of use of the present invention.

FIG. 5 is a fourth schematic view illustrating the flow of use of the present invention.

FIG. 6 is a flow chart illustrating steps of the present invention.

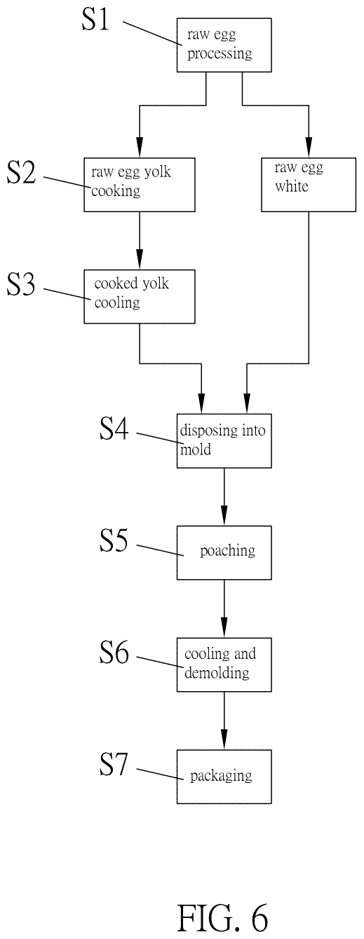

### DETAILED DESCRIPTION OF THE PREFERRED EMBODIMENTS

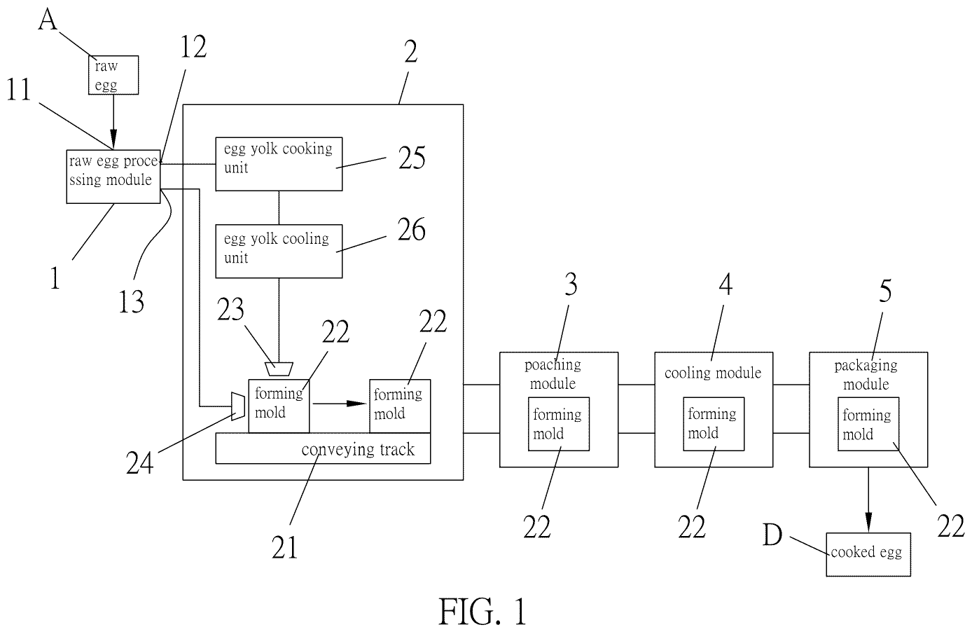

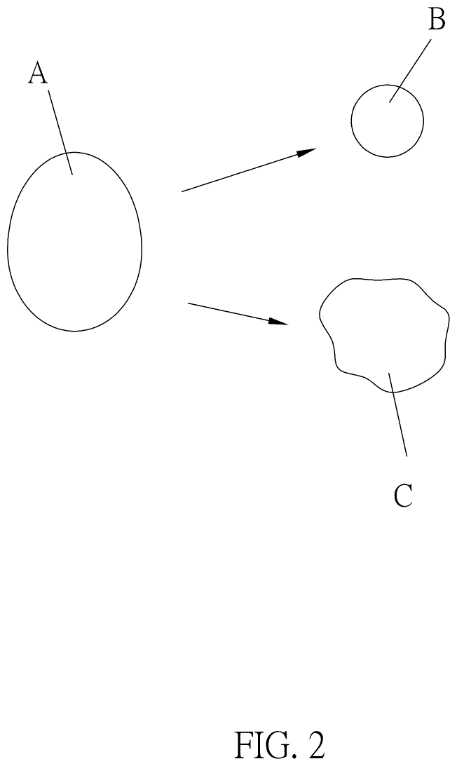

Referring to FIGS. 1 and 2, which provide illustrations of embodiments of the present invention, the drawings show that a poached egg preparation machine according to the present invention comprises:
a raw egg processing module 1, which comprises a raw egg input end 11, an egg yolk output end 12, and an egg white output end 13, wherein a plurality of raw eggs A are fed in through the raw egg input end 11 and the raw egg processing module 1 is operable to separate a raw egg yolk B and a raw egg white C of each of the raw eggs A.

Referring to FIG. 1, an egg yolk cooking and cooling molding module 2 comprises a conveying track 21, a plurality of forming molds 22, a plurality of egg yolk disposing elements 23, a plurality of egg white nozzles 24, an egg yolk cooking unit 25, and an egg yolk cooling unit 26.

Each of the forming molds 22 is detachably arranged on the conveying track 21, and each of the forming molds 22 has a degree of freedom to rotate horizontally and flip; each of the egg yolk disposing elements 23 and each of the egg white nozzles 24 are arranged at one end of the conveying track 21, and the egg white nozzles 24 are connected to the egg white output end 13; the egg yolk cooking unit 25 and the egg yolk cooling unit 26 are connected and are arranged in sequence between the egg yolk output end 12 and each of the egg yolk disposing elements 23.

Each of the raw egg yolks B enters the egg yolk cooking unit 24 from the egg yolk output end 12 to be cooked into a plurality of cooked yolks B1, and each of the cooked yolks B1 enters the egg yolk cooling unit 26 for low temperature cooling so as to have the cooked yolk B1 completely cooled.

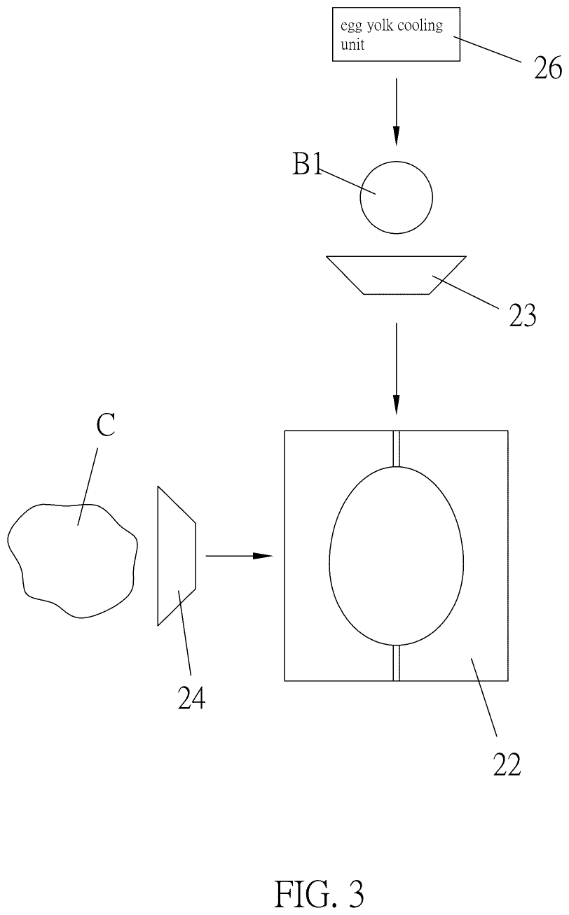

Referring to FIGS. 1 and 3, each of the egg white nozzles 24 fills the raw egg white C into each of the forming molds 22, and each of the egg yolk disposing elements 23 disposes each of the cooked yolks B1 into the raw egg white C in each of the forming molds 22.

In FIG. 3, for the operation of filling into the forming mold 22 that has an egg-shape carried out by the egg yolk disposing elements 23 and the egg white nozzles 24, a portion of the raw egg white C is first filled and slightly heated for solidification and then, the cooked yolk B1 is filled in. The cooked yolk B1 is placed, just like stuffing, in a center area of the raw egg white C (where the cooked yolk is located at the center of the raw egg white C), in order to ensure that the cooked yolk B1 is covered by the raw egg white C. Afterwards, the forming mold 22 is moved to the poaching module 3. The forming mold 22 may have a rotating shaft to allow the egg-shaped part to rotate horizontally and flip. The horizontal rotation and flip may continue during the course of movement of the forming molds 22 for poaching, so as to set the cooked yolk B1 in the center without touching the forming mold 22, thereby keeping a finished cooked egg D beautiful.

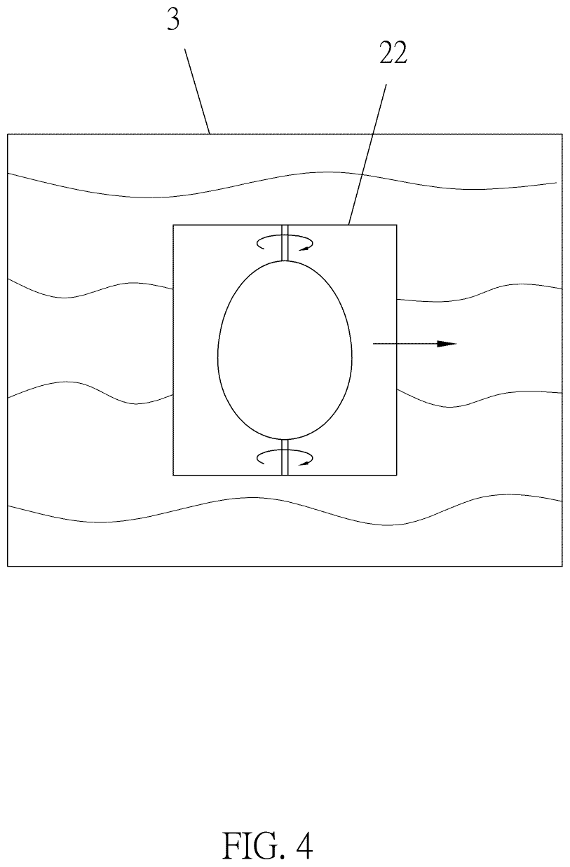

Referring to FIGS. 1, 4, and 5, a poaching module 3 is connected to an output end of the conveying track 21, and the poaching module 3 receives and heats each of the forming molds 22 to have the raw egg white C cooked into a cooked egg white C1, wherein in each of the forming molds 22, the cooked egg white C1 covers and encloses the cooked yolk B1 to form a cooked egg D, achieving the highest yield.

A cooling module 4 is connected to an output end of the poaching module 3, and the cooling module 4 receives and cools, at a low temperature, each of the forming molds 22, so that after cooling, the cooked egg D can be demolded and taken out.

Being completely cooled by the cooling module 4 to maintain hygiene can completely solve the food safety issues caused by yield loss and insufficient cooling of the cooked egg D.

In the above, the temperatures of the egg yolk cooling unit 25 and the cooling module 4 are set to −5 degrees to 5 degrees Celsius.

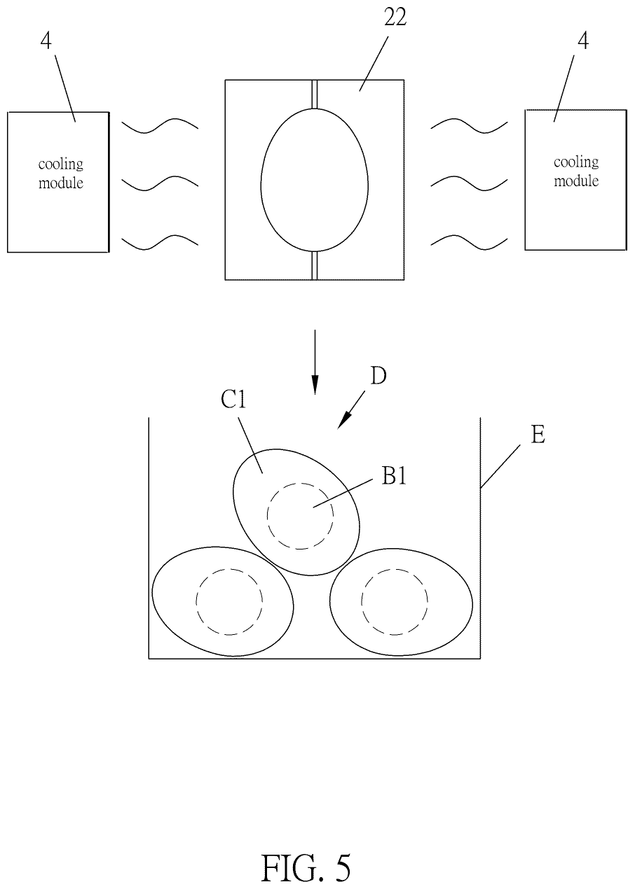

In the instant embodiment, a packaging module 5 is further included and connected to an output end of the cooling module 4. When the forming molds 22 are cooked in the poaching module 3 and are completely cooled in the cooling module 4, the forming molds 22 are moved to the packaging module 5. The forming molds 22, as shown in FIG. 5, after being completely cooled in the cooling module 4, are moved to the packaging module 5 to open and release the cooked egg D for implementing packaging. The packaging can be done for being packaged in a barrel or being packaged in bags. In FIG. 5, the cooked eggs D are placed and packaged in a barrel E. The cooling module 4 can use cold water or cold air to achieve complete cooling. The present invention can control the size and weight of the finished product of cooked egg D by using forming molds 22 of different capacities, in order to meet the size requirements of different businesses.

The forming molds 22 are each a product of metal or a product of a food grade material, such as stainless-steel molds or filling bags.

Different from the prior art that first cooking and then peeling off the eggshell, the present invention takes out cooked egg of a raw egg A and placing in a forming mold 22 for molding, and then cooking and cooling, and in addition, the raw egg yolk B is first cooked into cooked yolk B1 to be then fully cooled before stuffed or filled into the forming mold, and is poached and then fully cooled to allow the production line yield of cooked eggs D to reach 100%, thereby avoiding the waste of raw materials and the related food safety problems caused by insufficient cooling.

In general, steps of a poached egg preparation method according to the present invention include:
raw egg processing S1, in which a plurality of raw eggs are placed in a raw egg processing module 1, and the raw egg processing module 1 cracks eggshells and separates the raw egg yolk B and the raw egg white of each of the raw eggs A;
raw egg yolk cooking S2, in which the raw egg yolks B are cooked by an egg yolk cooking unit 26 to form a plurality of cooked yolks B1;
cooked yolk cooling S3, in which each of the cooked yolks B1 enters an egg yolk cooling unit 25 for low temperature cooling;
disposing into mold S4, in which the raw egg white C is fed through a plurality of egg white nozzles 24 into a plurality of forming molds 22, and the cooked yolks B1 are respectively disposed into the raw egg whites C in the forming molds 22 by means of a plurality of egg yolk disposing elements 23;
poaching S5, in which the forming molds 22 that contain the raw egg whites C and the cooked yolks B1 are heated by a poaching module 3 to have the raw egg whites C cooked into cooked egg whites C1, and in each of the forming molds 22, the cooked egg white C1 covers and encloses the cooked yolk B1 to form a cooked egg D; and
cooling and demolding S6, in which each of the forming molds 22 is cooled at a low temperature by a cooling module 4, and each of the forming molds 22 is then opened to take out the cooked egg D.

The method optionally includes the following step: packaging S7, in which the cooked eggs D are classified and packaged according to a predetermined quantity or a predetermined weight.

I claim:

1. A poached egg preparation machine, comprising:
a raw egg processing module, which comprises a raw egg input end, an egg yolk output end, and an egg white output end, wherein a plurality of raw eggs enters through the raw egg input end and the raw egg processing module separates each of the raw eggs into a raw egg yolk and a raw egg white;
an egg yolk cooking and cooling molding module, which comprises a conveying track, a plurality of forming molds, a plurality of egg yolk disposing elements, a plurality of egg white nozzles, an egg yolk cooking unit, and an egg yolk cooling unit, wherein each of the forming molds is detachably arranged on the conveying track, and each of the forming molds is rotatable and flipping horizontally; each of the egg yolk disposing elements and each of the egg white nozzles are arranged at one end of the conveying track, and the egg white nozzles are connected to the egg white output end;
the egg yolk cooking unit and the egg yolk cooling unit are connected and are arranged in sequence between the egg yolk output end and each of the egg yolk disposing elements, and the raw egg yolks enter the egg yolk cooking unit from the egg yolk output end to be cooked into a plurality of cooked yolks, and each of the cooked yolks enters the egg yolk cooling unit for low temperature cooling; each of the egg white nozzles fills the raw egg white into each of the forming molds, and each of the egg yolk disposing elements disposes each of the cooked yolks into the raw egg white in each of the forming molds;
a poaching module, which is connected to an output end of the conveying track, wherein the poaching module receives and heats each of the forming molds to have the raw egg white cooked into a cooked egg white, wherein in each of the forming molds, the cooked egg white covers the cooked yolk to form a cooked egg; and
a cooling module, which is connected to an output end of the poaching module, and the cooling module receives and cools, at a low temperature, each of the forming molds.

2. The poached egg preparation machine according to claim 1, further comprising a packaging module, which is connected to an output end of the cooling module, wherein each of the forming molds opens in the packaging module to release the cooked egg that is then subjected to packaging.

3. The poached egg preparation machine according to claim 1, wherein each of the forming molds is made of metal or a food grade material.

4. The poached egg preparation machine according to claim 1, wherein temperatures of the egg yolk cooling unit and the cooling module are set to −5 degrees to 5 degrees Celsius.

5. A poached egg preparation method, comprising the following steps:
raw egg processing, wherein a plurality of raw eggs are placed into a raw egg processing module, and the raw egg processing module cracks eggshells and separates raw egg yolk and raw egg white of each of the raw eggs;
raw egg yolk cooking, wherein the raw egg yolks are cooked by an egg yolk cooking unit to form a plurality of cooked yolks;
cooked yolk cooling, wherein each of the cooked yolks enters an egg yolk cooling unit for low temperature cooling;
disposing into mold, wherein the raw egg white is fed through a plurality of egg white nozzles into a plurality of forming molds, and the cooked yolks are respectively disposed the raw egg whites in the forming molds by means of a plurality of egg yolk disposing elements;
poaching, wherein the forming molds containing the raw egg whites and the cooked yolks are heated by a poaching module to have the raw egg whites cooked into cooked egg whites, wherein in each of the forming molds, the cooked egg white covers the cooked yolk to form a cooked egg; and
cooling and demolding, wherein each of the forming molds is cooled at a low temperature by a cooling module, and each of the forming molds is then opened to take out the cooked egg; and
the method optionally comprises:
packaging, in which the cooked eggs are classified and packaged according to a predetermined quantity or a predetermined weight.

6. The poached egg preparation method according to claim 5, wherein temperatures of the egg yolk cooling unit and the cooling module are set to −5 degrees to 5 degrees Celsius.
